(19) United States
(12) Patent Application Publication
(10) Pub. No.: US 2025/0140223 A1
(43) Pub. Date: May 1, 2025

(54) METHOD OF, AND A SYSTEM FOR, GENERATING AN AUDIO OUTPUT FILE VIA A COMPUTER SYSTEM

(71) Applicant: IAIAI TECHNOLOGIES LIMITED, Tulla (IE)

(72) Inventor: Michael KIELY, Tulla (IE)

(73) Assignee: IAIAI TECHNOLOGIES LIMITED, Tulla (IE)

(21) Appl. No.: 18/932,973

(22) Filed: Oct. 31, 2024

(30) Foreign Application Priority Data
Nov. 1, 2023 (IE) S2023/0462

(51) Int. Cl. G10H 1/00

(52) U.S. Cl. CPC G10H 1/0025; G10H 1/0066; G10H 2210/561; G10H 2250/311

(57) ABSTRACT

A method of generating an audio output file via a computer system includes receiving one or more audio files including musical tracks; separating each audio file into at least one selectable audio block; selecting an audio block and analysing the harmonic chord structure of the musical track; determining a new harmonic chord structure; and adapting the musical track to the new harmonic chord structure. The system for outputting an audio file includes a unique identifier module; a chord progression constructor; an instrument role allocator; a melodic DNA transposer; a musical elements analyst; an element selector module; an integration & adaptation module; a genre application module; an integration & adaptation module; and a genre application module. The system includes an interactive user editing control panel, aimed at offering extensive control over various musical aspects within an AI generated music track. The output file can be an audio file or MIDI file.

This application claims the benefit of priority to Irish Patent Application No. S2023/0462 filed Nov. 1, 2023, the contents of which are incorporated by reference herein for all purposes.

The present invention relates to a method of, and a system for, generating an audio output file via a computer system.

### BACKGROUND TO THE INVENTION

It will be appreciated by those in the industry, that the uneasy overlap between generative Artificial Intelligence (AI) and copyright law may result in several complex problems developing for copyright holders as well as technology users and developers. More particularly, the use of generative Artificial Intelligence (AI) causes significant problems in identifying and enforcing copyright, within areas of music generation and the like.

More particularly, training open AI models on copyrighted music without proper licensing or permissions is causing several problems. In this regard, using copyrighted music without authorization violates the rights of the copyright holders which often leads to legal consequences such as cease-and-desist notices, lawsuits, and potential financial penalties.

When an AI model is trained on copyrighted music it may inadvertently generate content that infringes on the intellectual property rights of artists, composers, and record labels thus leading to disputes over ownership and potential claims against the creators or users of the AI-generated music.

It will be appreciated by those in the industry, that if an AI model generates music that closely resembles a copyrighted work, it becomes challenging to ensure fair compensation and royalties for the original creators, affecting the livelihood of artists and hindering the development of a sustainable music industry.

It will further be appreciated that existing systems that deliver AI-generated music (derived from pre-existing copyrighted material) generally fail to properly attribute the original artists or composers. Lack of recognition undermines the acknowledgment and respect owed to the creators, potentially eroding the incentive for future artistic endeavors.

As such, it will be appreciated that there is a desperate need for a plan that considers the legal and ethical implications of technology, to make sure AI develops in the right way, i.e., that it respects existing copyright in musical works. This is also a problem ethically, because it's important to respect the rights of people who create original musical works. The problem on the one hand is that generative AI has the potential to develop amazing new musical creations. On the other hand, we need to ensure we don't step on the toes of copyright holders through these developments.

The gravity of the issue lies in the substantial legal implications. The AI industry is grappling with an alarming increase in lawsuits filed by copyright holders against AI companies, signaling a strenuous conflict between technological innovation and intellectual property rights. The intricacy of detecting copyright infringements, coupled with the challenges posed by compliance with intellectual property laws, complicate the issue.

There is an urgent need for innovative solutions and improved legal frameworks that can effectively address these issues, balancing the rights of musical copyright holders with the progress of AI technologies.

### SUMMARY OF THE INVENTION

According to a first aspect of the invention, there is provided a method of generating an audio output file via a computer system, the method includes one or more of the following:
receiving one or more audio files including musical tracks;
separating each audio file into at least one selectable audio block;
selecting an audio block and analysing the harmonic chord structure of the musical track;
determining a new harmonic chord structure; and
adapting the musical track to the new harmonic chord structure, the output file being an audio file or a MIDI file

In an embodiment of the invention, each audio block includes audio content from a musical instrument involved in creating the audio track.

In an embodiment of the invention, the step of determining a new harmonic chord structure includes changing the musical structure of certain musical notes by reassigning the notes to new frequencies and/or new note values, thus changing the melodic structure of the original audio music file.

In an embodiment of the invention, the step of selecting an audio block may include selecting audio blocks from other, unrelated musical tracks or audio files.

In an embodiment, the method described hereinbefore is repeated with each selected audio block.

In an embodiment, within the step of adapting the musical track to the new harmonic chord structure, despite the original harmonic chord structure differing between selected tracks, as they originate from different songs, each file will be given the same new destination harmonic chord structure. In this embodiment, each audio block music performance will be adapted or changed in the same way. In this embodiment, the audio blocks will then be synthesized (combined) to output a new unique music file.

In an embodiment, the method includes the step of providing a user with full creative control over mix and other parameters to modify the audio file generated. In this embodiment, the method includes the step of recording audio files. In this embodiment, the method includes the step of editing and mixing audio files.

In some embodiments, a methodology, algorithm or set of criteria for altering a musical work can be provided within an application tool. In some embodiments, the musical work alteration is facilitated through auto-training which includes one or more feedback loops. Thus, upon altering a musical work, the music alteration (or reference data information related to the intricate interplay of melody, harmony, and rhythm within a digital environment) can be fed back (e.g., a recursive loop) to the auto-training process for subsequent musical alterations. Some embodiments comprise an automated learning model, such as an AI model. Some embodiments comprise a simplified method for musical code modifications or a method of fusing various musical elements, to generate a unique or inventive soundscape. Some embodiments comprise a slider or other control for adjusting parameters of interest. It some embodiments, the musical work can be uploaded to the AI model and the AI model can experiment with musical codes and harmonies and infuse fresh angles into known tunes. In an embodiment, the AI model can reshape existing melodies, to delve into uncharted musical territories and possibly discover novel coding paradigms.

In an embodiment, the AI model is operable to learn how melodies can be altered, how codes can be tweaked to evoke different emotional responses, and how disparate musical elements can be seamlessly unified to create a cohesive piece.

In another embodiment of the invention, the method includes one or more of the following steps:
receiving a vocal recording of a melody,
autonomously generating music to accompany the melody, and
outputting a finished song. In this embodiment of the invention, the method includes the step of analysing and modifying a pre-existing melody, such as for example, “Twinkle Little Star”, with the objective of creating a new musical interpretation of the melody.

In this embodiment, the step of generating music to accompany the melody, includes one or more of the following steps:
analysing a melodic structure,
selecting one or more notes from the melodic structure,
assigning a value to each of the one or more notes,
modifying a harmonic chord structure,
transposing a key,
diversifying note destinations, and/or
exploring alternative and/or advanced chords.

In this embodiment, the step of analysing melodic structures includes identifying a song's key (e.g., C Major) and simplifying the melody's structure into a sequence such as C-C-G-G-A-A-G, F-F-E-E-D-D-C, G-G-F-F-E-E-D, G-G-F-F-E-E-D, C-C-G-G-A-A-G, F-F-E-E-D-D-C. In this embodiment, this step incudes selecting specific notes within the melody to modify. In an example embodiment, notes C and G could be chosen for modification.

In this embodiment, the step of assigning a value to each of the one or more notes includes the following: upon receipt of a note selection, assigning new musical values to the selected note. In an example embodiment, C might be reassigned to D, and G to A. In this embodiment, a transformed melody is created that maintains the rhythm and structural aspects of the original composition.

In this embodiment, the step of modifying a harmonic chord structure includes significantly altering the new composition to thereby provide it with a new context and tonal quality. It will be appreciated that this introduces new opportunities for melodic development.

In this embodiment, the step of transposing a key includes contemplating a shift in the key of the melody. In an example embodiment, “Twinkle Little Star” might be changed from C Major to G Major, creating a different tonal center that significantly influences the overall mood and character of the composition.

In this embodiment, the step of diversifying note destinations includes the AI model recognizing that altering chords offers new potential destinations for the melody's notes, resulting in unexpected and intriguing melodic variations.

In this embodiment, the step of exploring alternative and/or advanced chords includes offering experimentation with extended, altered, and substituted chords. In this embodiment, these advanced chords add additional notes, provide fresh destinations for the melody and enhance its harmonic richness.

In this embodiment, the method further includes the step of ensuring that new chords harmoniously support the melody, to create a cohesive and harmonically pleasing musical piece. Within the example embodiment, a distinct rendition of “Twinkle Little Star” is created which retains its familiar elements while venturing into new melodic and harmonic territories.

In some embodiments, a methodology, algorithm or set of criteria for generating music to accompany the melody can be provided within an application tool. In some embodiments, the music generation is facilitated through auto-training which includes one or more feedback loops. Thus, upon receipt of the vocal recording of the melody, the music generation (or reference data information related to creating a cohesive and harmonically pleasing musical piece) can be fed back (e.g., a recursive loop) to the auto-training process for subsequent musical alterations. Some embodiments comprise an automated learning model, such as an AI model. Some embodiments comprise a simplified method for music creation or a method of melody transformation through the creation of music which harmoniously supports the melody. Some embodiments comprise a slider or other control for adjusting parameters of interest. It some embodiments, the vocal recording of the melody can be uploaded to the AI model and the AI model can experiment with new melodic and harmonic musical creations. In an embodiment, the AI model can reshape existing melodies, to delve into uncharted musical territories and possibly discover novel coding paradigms.

In an embodiment, the method further includes analysing an original musical work to formulate a unique digital profile of the work;
storing one or more analysed musical works along with their digital profiles; and
upon a generative Artificial Intelligence (AI) model creating a new musical derivate work, tracing reference training data of the derivative work to identify one or more original musical works that have informed the new derivative work.

In an embodiment, the step of storing one or more analysed musical works includes the step of establishing a content structure within the Artificial Intelligence (AI) system. In this embodiment, the content structure outlines a central repository, such as a database, of the musical works. In an example of this embodiment, each of the musical works in the database will be automatically examined in detail before being allocated a distinct digital musical profile. In an embodiment, original musical works are preserved, monitored, and faithfully transmitted. In this embodiment, musical copyright holders for each piece of music are meticulously identified and documented, involving extensive cross-referencing and verification for accuracy.

In an embodiment of the invention, upon an Artificial Intelligence (AI) system creating a new derivate musical work, the method includes the step of identifying all the associated artists and rights holders who have influenced the new derivative musical work, to enable the artists and rights holders to be attributed as musical copyright beneficiaries of the derivate musical work.

A system for outputting an audio file, the system including one or more of the following:
a unique identifier module;
a chord progression constructor;
an instrument role allocator;
a melodic DNA transposer;
a musical elements analyst;
an element selector module;
an integration & adaptation module;
a genre application module;
an integration & adaptation module; and
a genre application module, the outputted audio file being an audio file or a MIDI file

In this embodiment, the unique identifier module is operable to pinpoint the distinct qualities of each musical segment, such as key, pace, and rhythm. Within this embodiment, the musical segments can then be normalized to a uniform tempo, for instance, 102 beats per minute.

In this embodiment, the chord progression constructor is operable to construct a compatible chord progression that can be incorporated into all the musical segments. Within this embodiment, the constructor is operable to transpose each musical segment into a unified key that corresponds with the main melody and upholds tonal equilibrium.

In this embodiment, the instrument role allocator is operable to contemplate the specific roles of each instrument within the composition's framework. Within this embodiment, the allocator is operable to assign roles to each segment to ensure a balanced and harmonious composition.

In this embodiment, the melodic DNA transposer is operable to transfer the foundational essence of an original melody onto the new composition. Within this embodiment, the transposer is operable to create a novel, unified, and inventive piece that preserves its fundamental musical origin (akin to musical source code or musical foundation DNA).

In this embodiment, the musical elements analyst is operable to conduct a detailed analysis of various musical compositions. Within this embodiment, the analyst is operable to catalog all musical elements including melody, rhythm, harmony, timbre, and structure.

In this embodiment, the element selector module is operable to select parts or instrument performances from a range of unrelated audio recordings, creating a unique blend of musical elements.

In this embodiment, the integration and adaptation module is operable to adapt and merge diverse recorded elements to create a new, harmonious, and cohesive musical composition. Within this embodiment, the integration and adaptation module ensures the synergistic coexistence of each element, creating a rich auditory texture.

In this embodiment, the genre application module is operable to recognize the potential of this technique across different musical genres. Within this embodiment, the module is operable to create new music works in a number of different genres such as Rock, HipHop, Pop, EDM, Classical, Country etc., or within other, unique soundscapes including other intricate textures.

A system for outputting an audio file, the system including one or more of the following:
an interactive user editing control panel, aimed at offering extensive control over various musical aspects within an AI generated music track.

In an embodiment, the control panel forms an all-in-one suite of adjustment tools, enabling users to modify tempo, volume, reverb, and apply various filters to shape the acoustic qualities of a music piece.

In an embodiment the system further includes an instrument shuffling feature, allowing users to swap out the instruments used in the track for alternative performances of that instrument type

In an embodiment, the system further includes an instrument addition function, giving users the option to introduce new instruments of their choosing to the track.

For consumers, the system enhances their music listening experience by providing them with detailed information about the tracks they enjoy. This can deepen their connection with the music, as they gain a better understanding of its origins, the artists behind it, and the creative process involved in its production. In addition, the proliferation of AI-generated derivative works can lead to a richer and more diverse music landscape for consumers to explore, broadening their musical horizons.

Another key advantage of this method is the solving of a significant problem facing the music industry.

The present invention discloses a personalized music generation method and system that can be personalised to independent artists.

The system is designed so musicians, composers, and producers can enhance their creative capabilities while mitigating the risk of copyright infringement.

The system can be used to analyse and create derivative works from the catalog of even an individual artist by creating unique “DNA” profiles of an artists work by examining melodies and other distinctive characteristics, unlike conventional music generation systems that rely on extensive datasets comprising copyrighted material, the present invention operates exclusively on user-specific data. The system meticulously analyses the user's catalog of melodic compositions, arrangements, and stylistic nuances to establish a personalised musical or creative DNA profile of each work. This profile serves as the foundation for the system's subsequent music generation capabilities which are described and disclosed here as inventive steps.

This form of “creative DNA,” profiling, allows the system to generate new musical works that strongly reflect the artist's style while ensuring that all rights to these derivative works remain with the original artist.

In cases where an artist has passed away and has left behind a collection of unfinished works, this system can be used to complete the works by emulating the artist's compositional or creative style. This is made possible by the system analysing the melody and other aspects of an artists existing songs, such as chord structures, rhythm and even unfinished sections or other partial music moments captured in a recording. All of this informs the system in the creation of new material that helps finish a deceased artists work of which the copyright can be attributed to the artist or their estate, even after death.

As an example, if an artist has played a melodic riff on a guitar, the system can assign a new chord structure which underpins the melodic guitar riff and adapt the riff by changing certain notes to harmonically align with the new chord structure while keeping other musical aspects or expressions from the original performance as described herein.

The new chord passage assigned, is also influenced by chord structures from other works of the same artist, thus helping to maintain the artist's style or likeness.

By training solely on a living user's own body of work, this invention transcends the risk of infringing the copyright of other artists and musicians. The possibility of training a system solely on a single artist's catalog, avoids the contamination which occurs when we see other models being trained on the vast works of numerous artists, as is common in current music AI generation systems. This invention therefore discloses a method for music generation which remains entirely focused on one artist's body of work, thereby preventing copyright infringement.

Therefore, the methods disclosed in this system mimic the user's unique musical style, preferences, and nuances, enabling it to generate compositions that reflect the user's creative identity.

The system can function as a virtual companion, integrating into the user's creative workflow to provide intuitive suggestions, recommendations, and musical ideas, all similar in ways to a users works from their past.

One way the system can be accessed is through integration with a DAW (Digital Audio Workstation) or similar.

This novel approach to training data, also empowers users to expand on their work, while maintaining the integrity of their artistic style and creative expression.

MIDI, or Musical Instrument Digital Interface, is a technical standard that allows electronic musical instruments, computers, and other devices to communicate and synchronize with each other. It transmits digital information about musical performance, such as notes, pitch, velocity, and control signals, rather than audio signals. This allows for the representation of musical sequences and compositions in a compact format that can be easily edited, recorded, and played back on various devices. MIDI enables musicians and producers to create, modify, and control music with a high degree of precision and flexibility.

In the context of this patent, AUDIO and MIDI should be considered functionally equivalent in their ability to convey musical information. Both formats serve the essential purpose of representing musical values such as melodies, rhythms, and nuances effectively. AUDIO files capture the actual sound, providing the tangible auditory reference and MIDI encodes the performance data.

The MIDI file format is the obvious choice for those skilled in the art, as MIDI is a standard format used by professionals in the field for distributing digital information regarding musical notes, melodies, and performance data, including pitch, velocity, and duration. Its efficiency and versatility allow for the encapsulation of these parameters in a compact and editable format, facilitating seamless integration with various musical software and hardware. MIDI is the preferred method for transmitting musical information herein.

### BRIEF DESCRIPTION OF THE DRAWINGS

These and other features of this invention will become apparent from the following description of one example described with reference to the accompanying drawings in which:

FIG. 1 shows a system for generating an audio output file via a computer system, in accordance with an aspect of the invention;

FIG. 2 shows a system for generating an audio output file via a computer system, in accordance with an aspect of the invention;

FIG. 3 shows a system for generating an audio output file via a computer system, in accordance with an aspect of the invention;

FIG. 4 shows a system for generating an audio output file via a computer system, in accordance with an aspect of the invention;

FIG. 5 shows a system for generating an audio output file via a computer system, in accordance with an aspect of the invention;

FIG. 6 shows a system for generating an audio output file via a computer system, in accordance with an aspect of the invention; and

FIG. 7 shows a computer within which a set of instructions, for causing the computer to perform any one or more of the methodologies described herein, in accordance with aspects of the invention; and

FIG. 8 shows a method of generating an audio output file via a computer system, in accordance with aspects of the invention.

### DETAILED DESCRIPTION

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptions to the present invention are possible and can even be desirable in certain circumstances and are a part of the present invention. Thus, the following description is provided as illustrative of the principles of the present invention and limitation thereof.

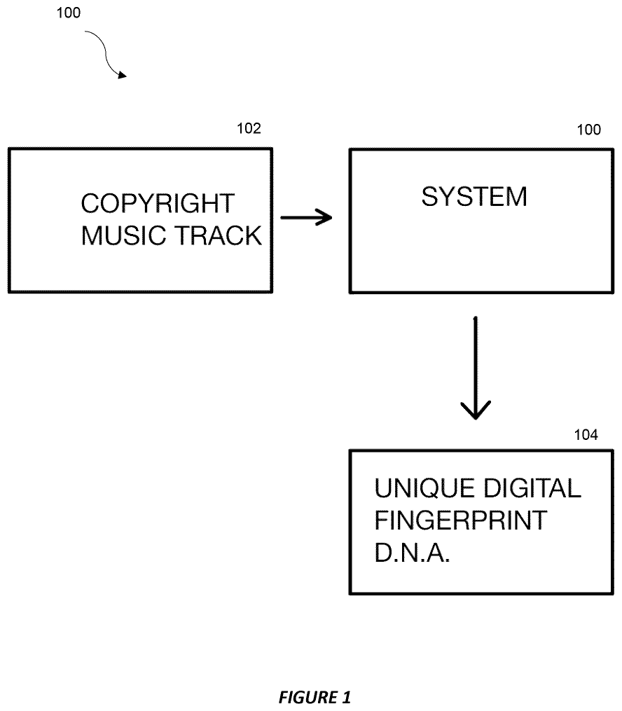

In FIG. 1, a system for generating an audio output file via a computer system, in accordance with an aspect of the invention, is generally described with reference to numeral 100.

In use, the system 100 includes a copyright music track 102, which is uploaded to the system 100. In turn, the system 100 analyses the music track 102 and creates a unique digital fingerprint (akin to DNA) 104 for the music track 102. The associated digital profile 104 is linked to the human authors and copyright owners of the music work 102.

The original master work's unique digital fingerprint or digital profile 104 is stored in a databank for retrieval during lineage assessment and search at the time of AI generating new musical works.

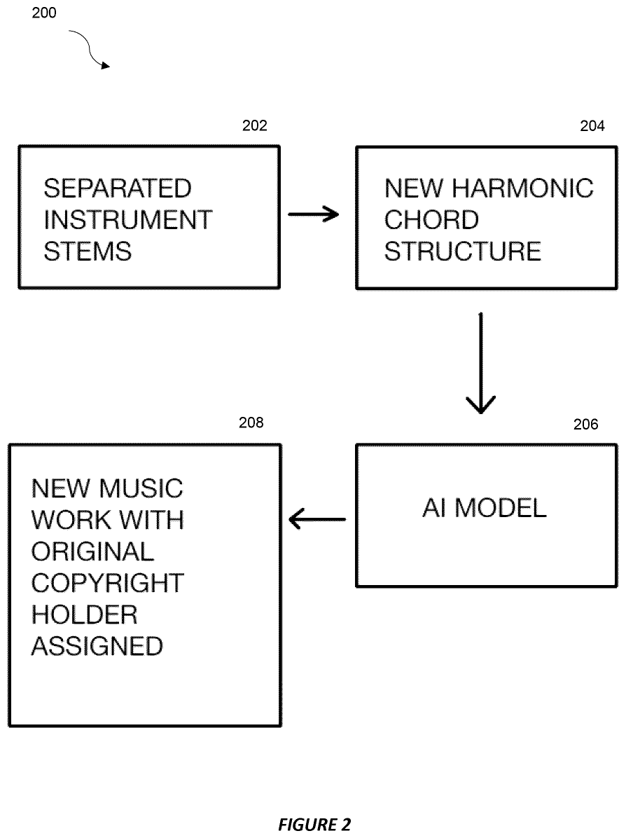

In FIG. 2, a system generating an audio output file via a computer system, in accordance with an aspect of the invention, is generally described with reference to numeral 200.

In use, upon receipt of an audio file including a musical work, the music is separated into multiple instrument stems 202. A new harmonic chord structure 204 is then selected for the musical work. An Artificial Intelligence (AI) model 206 is used to then adapt the musical track to the new harmonic chord structure 204. The new musical work 208 will have the original copyright holders duly assigned thereto.

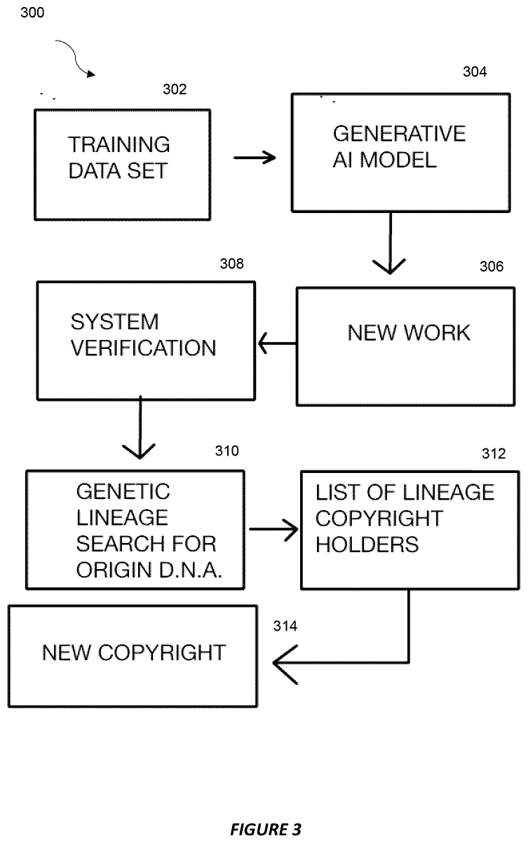

In FIG. 3, a system generating an audio output file via a computer system, in accordance with an aspect of the invention, is generally described with reference to numeral 300.

In accordance with embodiments, one of the aspects of the invention is its ability to assess works generated by AI models which have previously been trained on both copyright works and other data, the origin of which precede this invention. An example is any AI model currently generating new or derivative works that cannot show any lineage to the original works which the AI model referenced during the generation of the new work.

The system 300 includes a training data set 302, a generative AI model 304, a new derivate work (that does not show any lineage to the original works referenced) 306, a system verification 308, a genetic lineage search 310, a list of lineage holders 312, new copyright 314.

In system 300, the data training set 302 is used to train a generative AI model 304. The generative AI model 304 outputs a new work 306. The new work 306 is sent to the system 300 for verification 308. The system 300 analyses the new work 306 and conducts an automatic search, tracing back the lineage of the new work 306 to its source of origin.

A profile of the original copyright holders whose works were used as an influence in the AI generated work is extracted and an assignment token is created.

New copyright 310 is then assigned to the new work with the names of the original copyright holders as beneficiaries of the new work.

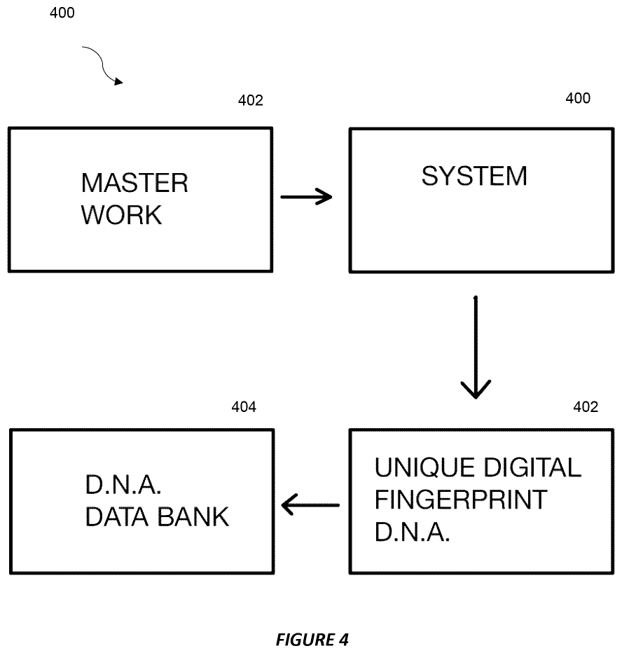

In FIG. 4, a system generating an audio output file via a computer system, in accordance with an aspect of the invention, is generally described with reference to numeral 400.

In use, the system 400 includes a master work 402, which is uploaded to the system 400. In turn, the system 400 analyses the master work 402 and creates a unique digital fingerprint (akin to DNA) 104 for the master work 402. The associated digital profile 404 is linked to the human authors and copyright owners of the master work 402.

The original master work's unique digital fingerprint or digital profile 404 is stored in a databank 406 for retrieval during lineage assessment and search at the time of AI generating new or derivative works.

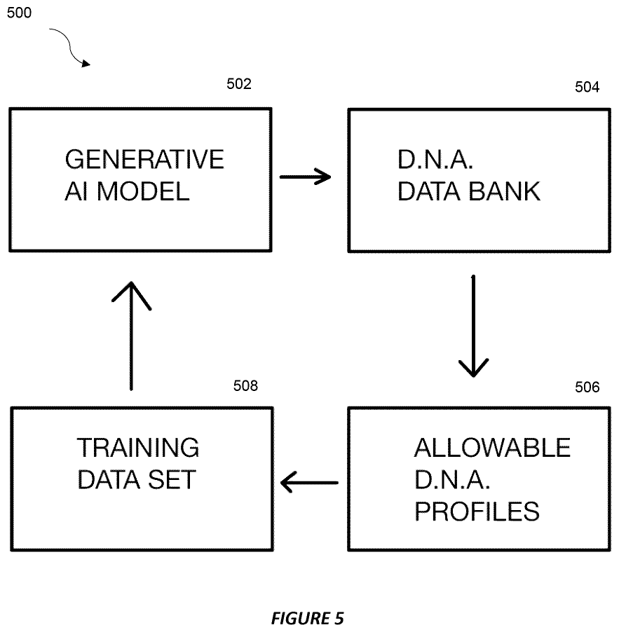

In FIG. 5, a system generating an audio output file via a computer system, in accordance with an aspect of the invention, is generally described with reference to numeral 500.

In use, a generative Artificial Intelligence (AI) model 502 sends a request to the databank 504 for a profiled data set.

The system 500 then compiles all relevant digital profiles matching the request 506. The system then creates a training data set 508 of only allowable profiled works.

The system 500 sends the requested training data set 508 to the generative AI model 502.

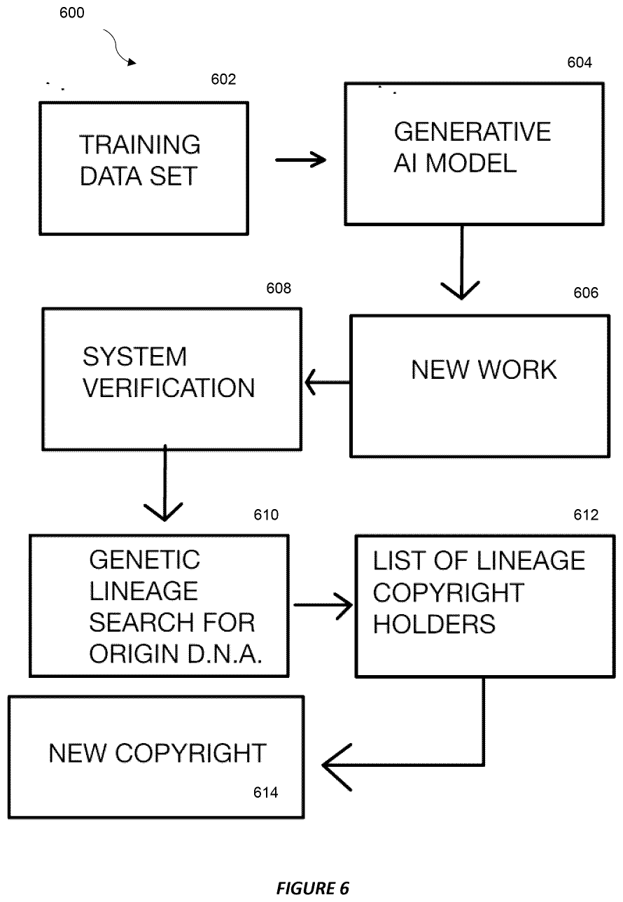

In FIG. 6, a system generating an audio output file via a computer system, in accordance with an aspect of the invention, is generally described with reference to numeral 600.

The system 600 includes a training data set 602, a generative AI model 604, a new derivate work (that does not show any lineage to the original works referenced) 606, a system verification 608, a genetic lineage search 610, a list of lineage holders 612, new copyright 614.

In the system 600, the data training set 602 is used to train a generative AI model 604. The generative AI model 604 outputs a new work 606. The new work 606 is sent to the system 600 for verification 608. The system 600 analyses the new work 606 and conducts an automatic search 610, tracing back the lineage of the new work 606 to its source of origin 612.

A profile of the original copyright holders whose works were used as an influence in the AI generated work is extracted and an assignment token is created.

New copyright is then assigned to the new work 614 with the names of the original copyright holders as beneficiaries of the new work.

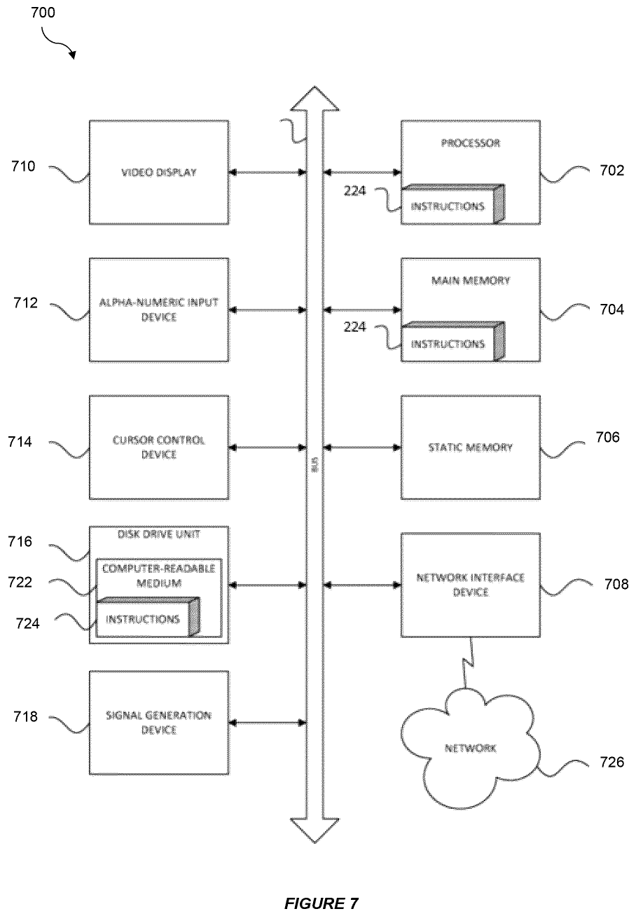

In FIG. 7, a computer within which a set of instructions, for causing the computer to perform any one or more of the methodologies described herein, may be executed. In accordance with embodiments of the invention, the computer is generally described with reference to numeral 700.

According to some embodiments, a computer 700 is disclosed which comprises: one or more processors; and a non-transitory computer-readable memory having stored therein computer-executable instructions, that when executed by the one or more processors, cause the one or more processors to perform actions comprising: analysing an original copyright work to formulate a unique digital profile of the work, storing one or more analysed copyright works along with their digital profiles, and upon a generative Artificial Intelligence (AI) model creating a new derivate work, tracing reference training data of the derivative work to identify one or more original copyright works that have informed the new derivative work.

In a networked deployment, the computer 700 may operate in the capacity of a server or a client machine in server-client network environment, or as a peer machine in a peer-to-peer (or distributed) network environment. The computer 700 may be a personal computer (PC), a tablet PC, a set-top box (STB), a Personal Digital Assistant (PDA), a cellular telephone, a web appliance, a network router, switch or bridge, or any computer 700 capable of executing a set of instructions (sequential or otherwise) that specify actions to be taken by that computer 700. Further, while only a single computer 700 is illustrated, the term “computer” shall also be taken to include any collection of computers that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer 700 may further include a video display unit 710 (e.g., a liquid crystal display (LCD)). The computer 200 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a computer-readable medium 722 on which is stored one or more sets of instructions and data structures (e.g., software 724) embodying or utilising any one or more of the methodologies or functions described herein. The software 724 may also reside, completely or at least partially, within the main memory 704 and/or within the processor during execution thereof by the computer system 400, the main memory and the processor also constituting computer-readable media. To this end, for clarity, please note that where the software 724 is not located in the main memory 704 and/or within the processor during execution thereof by the computer system 400, it will be in a cloud-based or remote storage location and may be executed directly from there.

The software 724 may further be transmitted or received over a network 726 via the network interface device 720 utilising any one of several well-known transfer protocols (e.g., HTTP, FTP).

In some embodiments the computer-readable medium 722 for carrying out the above-mentioned technical steps of the framework's functionality, is non-transitory in nature. The non-transitory computer-readable medium 722 has tangibly stored thereon, or tangibly encoded thereon, software 724 that when executed by a device (e.g., application server, messaging server, email server, ad server, content server and/or client device, and the like) cause at least one processor to perform a method for optimizing copyright protection within an Artificial Intelligence (AI) system. In accordance with one or more embodiments, a system is provided that comprises one or more computer systems 700 configured to provide functionality in accordance with such embodiments. In accordance with one or more embodiments, functionality is embodied in steps of a method performed by at least one computer. In accordance with one or more embodiments, software 724, program code (or program logic) executed by a processor(s) of a computer system 700 to implement functionality in accordance with one or more such embodiments is embodied in, by and/or on a non-transitory computer-readable medium 722.

While the computer-readable medium 722 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer system 700 and that cause the computer system 700 to perform any one or more of the methodologies of the present embodiments, or that is capable of storing, encoding or carrying data structures utilised by or associated with such a set of instructions. The term “computer-readable medium” shall accordingly be taken to include, but not be limited to, solid-state memories and optical and magnetic media as well as cloud storage options (such as Amazon Webservices™, Microsoft Azure™ and the like).

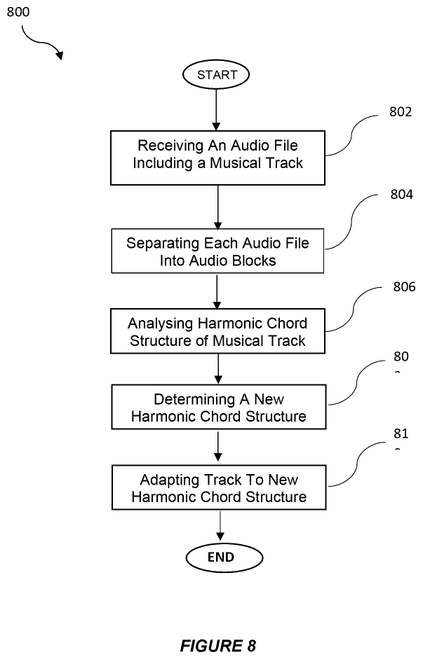

In FIG. 8, in accordance with the first aspect of the invention, a system generating an audio output file via a computer system, is generally described with reference to numeral 800.

The method 800 includes, at block 802, the step of receiving an audio file including a musical track.

At block 804, the method includes separating each audio file into at least one selectable audio block.

At block 806, method 800 includes selecting an audio block and analysing the harmonic chord structure of the musical track.

At block 808, the method includes determining a new harmonic chord structure. And, at block 810, the method includes adapting the musical track to the new harmonic chord structure.

It is to be understood that the invention is not limited to the specific details described herein which are given by way of example only and that various modifications and alterations are possible without departing from the scope of the invention as defined in the appended claims.

1. A method of generating an audio output file via a computer system, the method includes the following:
receiving one or more audio files including musical tracks;
separating each audio file into at least one selectable audio block;
selecting an audio block and analysing the harmonic chord structure of the musical track;
determining a new harmonic chord structure; and
adapting the musical track to the new harmonic chord structure, the output file being an audio file or a MIDI file.

2. A method as claimed in claim 1, wherein each audio block includes audio content from a musical instrument involved in creating the audio track.

3. A method as claimed in claim 1, wherein the step of determining a new harmonic chord structure includes changing the musical structure of certain musical notes by reassigning the notes to new frequencies and/or new note values, thus changing the melodic structure of the original audio music file.

4. A method as claimed in claim 1, wherein the step of selecting an audio block may include selecting audio blocks from other, unrelated musical tracks or audio files.

5. A method as claimed in claim 1, wherein the method described hereinbefore is repeated with each selected audio block.

6. A method as claimed in claim 1, wherein the step of adapting the musical track to the new harmonic chord structure, despite the original harmonic chord structure differing between selected tracks, as they originate from different songs, each file will be given the same new destination harmonic chord structure.

7. A method as claimed in claim 1, wherein each audio block music performance will be adapted or changed in the same way.

8. A method as claimed in claim 1, wherein the audio blocks will then be synthesized (combined) to output a new unique music file.

9. A method as claimed in claim 1, wherein the method includes the step of providing a user with full creative control over mix and other parameters to modify the audio file generated.

10. A method as claimed in claim 1, wherein the method includes the step of recording audio files.

11. A method as claimed in claim 1, wherein the method includes the step of editing and mixing audio files.

12. A method as claimed in claim 1, wherein a methodology, algorithm or set of criteria for altering a musical work is provided within an application tool.

13. A method as claimed in claim 1, wherein the musical work alteration is facilitated through auto-training which includes one or more feedback loops.

14. A method as claimed in claim 13, wherein, upon altering a musical work, the music alteration (or reference data information related to the intricate interplay of melody, harmony, and rhythm within a digital environment) can be fed back (e.g., a recursive loop) to the auto-training process for subsequent musical alterations.

15. A method as claimed in claim 1, comprising an automated learning model, such as an AI model.

16. A method as claimed in claim 1, comprising a simplified method for musical code modifications or a method of fusing various musical elements, to generate a unique or inventive soundscape.

17. A method as claimed in claim 1, including a slider or other control for adjusting parameters of interest.

18. A method as claimed in claim 15, wherein the musical work may be uploaded to the AI model and the AI model can experiment with musical codes and harmonies and infuse fresh angles into known tunes.

19. A method as claimed in claim 15, wherein, the AI model is operable to reshape existing melodies, to delve into uncharted musical territories and possibly discover novel coding paradigms.

20. A method as claimed in claim 1, wherein the AI model is operable to learn how melodies can be altered, how codes can be tweaked to evoke different emotional responses, and how disparate musical elements can be seamlessly unified to create a cohesive piece.

21. The method as claimed in claim 1, wherein the method includes one or more of the following steps:
receiving a vocal recording of a melody,
autonomously generating music to accompany the melody, and
outputting a finished song.

22. The method as claimed in claim 21, wherein method includes the step of analysing and modifying a pre-existing melody, such as for example, “Twinkle Little Star”, with the objective of creating a new musical interpretation of the melody.

23. The method as claimed in claim 21, wherein the step of generating music to accompany the melody, includes one or more of the following steps:
analysing a melodic structure,
selecting one or more notes from the melodic structure,
assigning a value to each of the one or more notes,
modifying a harmonic chord structure,
transposing a key,
diversifying note destinations, and/or
exploring alternative and/or advanced chords.

24. The method as claimed in claim 23, wherein the step of analysing melodic structures includes identifying a song's key (e.g., C Major) and simplifying the melody's structure into a sequence such as C-C-G-G-A-A-G, F-F-E-E-D-D-C, G-G-F-F-E-E-D, G-G-F-F-E-E-D, C-C-G-G-A-A-G, F-F-E-E-D-D-C.

25. The method as claimed in claim 23, wherein this step incudes selecting specific notes within the melody to modify.

26. The method as claimed in claim 25, wherein, in an example embodiment, notes C and G are chosen for modification.

27. The method as claimed in claim 23, wherein the step of assigning a value to each of the one or more notes includes the following: upon receipt of a note selection, assigning new musical values to the selected note. In an example embodiment, C might be reassigned to D, and G to A.

28. The method as claimed in claim 23, wherein a transformed melody is created that maintains the rhythm and structural aspects of the original composition.

29. The method as claimed in claim 23, wherein the step of modifying a harmonic chord structure includes significantly altering the new composition to thereby provide it with a new context and tonal quality.

30. The method as claimed in claim 23, wherein the step of transposing a key includes contemplating a shift in the key of the melody.

31. The method as claimed in claim 30, wherein the song “Twinkle Little Star” might be changed from C Major to G Major, creating a different tonal center that significantly influences the overall mood and character of the composition.

32. The method as claimed in claim 23, wherein the step of diversifying note destinations includes the AI model recognizing that altering chords offers new potential destinations for the melody's notes, resulting in unexpected and intriguing melodic variations.

33. The method as claimed in claim 23, wherein the step of exploring alternative and/or advanced chords includes offering experimentation with extended, altered, and substituted chords.

34. The method as claimed in claim 23, wherein these advanced chords add additional notes, provide fresh destinations for the melody and enhance its harmonic richness.

35. The method as claimed in claim 23, wherein the method further includes the step of ensuring that new chords harmoniously support the melody, to create a cohesive and harmonically pleasing musical piece.

36. The method as claimed in claim 35, wherein a distinct rendition of “Twinkle Little Star” is created which retains its familiar elements while venturing into new melodic and harmonic territories.

37. A method as claimed in claim 1, wherein the method further includes:
analysing an original musical work to formulate a unique digital profile of the work,
storing one or more analysed musical works along with their digital profiles, and
upon a generative Artificial Intelligence (AI) model creating a new musical derivate work, tracing reference training data of the derivative work to identify one or more original musical works that have informed the new derivative work.

38. A method as claimed in claim 37, wherein the step of storing one or more analysed musical works includes the step of establishing a content structure within the Artificial Intelligence (AI) system.

39. A method as claimed in claim 38, wherein the content structure outlines a central repository, such as a database, of the musical works.

40. A method as claimed in claim 38, wherein each of the musical works in the database will be automatically examined in detail before being allocated a distinct digital musical profile.

41. A method as claimed in claim 1, wherein original musical works are preserved, monitored, and faithfully transmitted.

42. A method as claimed in claim 1, wherein musical copyright holders for each piece of music are meticulously identified and documented, involving extensive cross-referencing and verification for accuracy.

43. A method as claimed in claim 1, wherein upon an Artificial Intelligence (AI) system creating a new derivate musical work, the method includes the step of identifying all the associated artists and rights holders who have influenced the new derivative musical work, to enable the artists and rights holders to be attributed as musical copyright beneficiaries of the derivate musical work.

44. A system for outputting an audio file, the system including the following:
a unique identifier module;
a chord progression constructor;
an instrument role allocator;
a melodic DNA transposer;
a musical elements analyst;
an element selector module;
an integration & adaptation module;
a genre application module;
an integration & adaptation module; and
a genre application module, the outputted audio file being an audio file or a MIDI file.

45. The system as claimed in claim 44, wherein the unique identifier module is operable to pinpoint the distinct qualities of each musical segment, such as key, pace, and rhythm.

46. The system as claimed in claim 45, wherein musical segments can be normalized to a uniform tempo, for instance, 102 beats per minute.

47. The system as claimed in claim 44, wherein the chord progression constructor is operable to construct a compatible chord progression that can be incorporated into all the musical segments.

48. The system as claimed in claim 47, wherein the constructor is operable to transpose each musical segment into a unified key that corresponds with the main melody and upholds tonal equilibrium.

49. The system as claimed in claim 44, wherein the instrument role allocator is operable to contemplate the specific roles of each instrument within the composition's framework.

50. The system as claimed in claim 49, wherein the allocator is operable to assign roles to each segment to ensure a balanced and harmonious composition.

51. The system as claimed in claim 44, wherein the melodic DNA transposer is operable to transfer the foundational essence of an original melody onto the new composition.

52. The system as claimed in claim 44, wherein the transposer is operable to create a novel, unified, and inventive piece that preserves its fundamental musical origin (akin to musical source code or musical foundation DNA).

53. The system as claimed in claim 44, wherein the musical elements analyst is operable to conduct a detailed analysis of various musical compositions.

54. The system as claimed in claim 53, wherein the analyst is operable to catalog all musical elements including melody, rhythm, harmony, timbre, and structure.

55. The system as claimed in claim 44, wherein the element selector module is operable to select parts or instrument performances from a range of unrelated audio recordings, creating a unique blend of musical elements.

56. The system as claimed in claim 44, wherein the integration and adaptation module is operable to adapt and merge diverse recorded elements to create a new, harmonious, and cohesive musical composition.

57. The system as claimed in claim 44, wherein the integration and adaptation module ensures the synergistic coexistence of each element, creating a rich auditory texture.

58. The system as claimed in claim 44, wherein the genre application module is operable to recognize the potential of this technique across different musical genres.

59. The system as claimed in claim 44, wherein the module is operable to create new music works in a number of different genres such as Rock, HipHop, Pop, EDM, Classical, Country etc., or within other, unique soundscapes including other intricate textures.

60. A system for outputting an audio file, the system including:
an interactive user editing control panel, aimed at offering extensive control over various musical aspects within an AI generated music track.

61. The system as claimed in claim 60, wherein the control panel forms an all-in-one suite of adjustment tools, enabling users to modify tempo, volume, reverb, and apply various filters to shape the acoustic qualities of a music piece.

62. The system as claimed in claim 60, wherein the system further includes an instrument shuffling feature, allowing users to swap out the instruments used in the track for alternative performances of that instrument type.

63. The system as claimed in claim 60, wherein the system further includes an instrument addition function, giving users the option to introduce new instruments of their choosing to the track.
